(19) United States
(12) Patent Application Publication
(10) Pub. No.: US 2003/0017407 A1
(43) Pub. Date: Jan. 23, 2003

(54) Color imaging toner, color image forming method and color image forming apparatus

(75) Inventors: Yasushige Nakamura, Kawasaki (JP); Shinichi Yaoi, Kawasaki (JP); Tomoaki Tanaka, Kawasaki (JP); Yoshimichi Katagiri, Kawasaki (JP)

Correspondence Address: ARMSTRONG,WESTERMAN & HATTORI, LLP, 1725 K STREET, NW., SUITE 1000, WASHINGTON, DC, 20006, US

(73) Assignee: FUJITSU LIMITED, Kawasaki (JP)

(21) Appl. No.: 09/931,082

(22) Filed: Aug. 17, 2001

(30) Foreign Application Priority Data
Mar. 30, 2001 (JP) 2001-101199

(51) Int. Cl. G03G 9/097

(52) U.S. Cl. 430/108.21; 430/108.1; 430/108.5; 430/108.3; 430/124

(57) ABSTRACT

In an electrophotographic color toner which contains at least a binder resin and a colorant, a calixarene compound is used in combination with an infrared absorbing compound which shows a light absorption peak at a wavelength ranging from 700 to 1000 nm.

### BACKGROUND OF THE INVENTION

1. Field of the Invention

The present invention relates to an imaging toner and, more particularly, to an color imaging toner, suited for use in electrophotography, employing a photofixing system. The color imaging toner of the present invention which will be also referred hereinafter to a color toner can be used advantageously as a developing agent in various imaging apparatuses employing electrophotographic and other systems, for example, an electrophotographic copying machine, an electrophotographic facsimile, an electrophotographic printer and an electrostatic printing machine. The present invention also relates to a color image forming method and a color image forming apparatus, which employ the color imaging toner.

2. Description of Related Art

The electrophotographic system which has been widely used in copying machines, printers and printing machines generally charges the surface of a photoconductive insulator such as a photosensitive drum uniformly with positive or negative electrostatic charge. After the uniform charging, the electrostatic charge on the insulating material is partially erased by irradiating the photoconductive insulator with image light, by various means, thereby to form an electrostatic latent image. For example, an electrostatic latent image corresponding to image information can be formed on the photoconductive insulator by erasing the surface charge from particular portions by irradiating them with a laser beam. Then a fine powder of a developing agent, referred to as a toner, is caused to deposit on the latent image where the electrostatic charge remains on the photoconductive insulator, thereby to visualize the latent image. Last, in order to print the toner image obtained as described above, it is common to electrostatically transfer the image onto a recording medium such as recording paper.

For fixing the transferred toner image, such methods as a fixing method wherein toner is molten by pressurization, heating or a combination thereof and is then solidified or a fixing method wherein toner is molten by irradiating with light and is then solidified have been employed, while much interest it being directed to a method referred to as a photofixing method (also referred to as a flash fixing method) which uses light that is free from the adverse effects of pressurization and heating. In the photofixing method, since it is not necessary to apply a pressure to the toner during fixation, the need to bring the toner into contact (pressurization) with a fixing roller or the like is eliminated, and an advantage is provided where imaging resolution (reproducibility) experiences less degradation in the fixing step. Also, because it is not necessary to heat the toner with a heat source, there is no need to have a preheating time which is essential to heat the heating medium (fixing roller or the like) to a predetermined operating temperature, so that printing can be immediately started upon turning on the power. Eliminating the need for a high temperature heat source has another advantage that the temperature in the apparatus does not rise. It also eliminates such a danger that the recording paper catches fire due to the heat generated by the heat source, even when the recording paper jams in the fixing device due to a system breakdown or other trouble.

However, a color toner has a low efficiency for absorbing light and, when the photofixing method is applied to the fixation of color toner, the fixability is lower than that in the case of fixing a black toner. Thus it has been proposed to improve the fixability by adding an infrared absorbing agent to the color toner, and many patent applications related to this technology, such as: Japanese Unexamined Patent Publications (Kokai) No. 60-63546, No. 60-57858, No. 60-57857, No. 58-102248, No. 50-102247, No. 60-131544, No. 60-133460 and No. 61-132959, WO99/13382, and Japanese Unexamined Patent Publications (Kokai) No. 2000-147824, No. 7-191492, No. 2000-155439, No. 6-348056, No. 10-39535, No. 2000-35689, No. 11-38666, No. 11-125930, No. 11-125928, No. 11-125929 and No. 11-65167, have been laid-open. Technologies disclosed in these publications are attempts to make color rendering and photofixability compatible with each other by adding an infrared absorbing agent to the toner. However, all of the infrared absorbing agents proposed have the problem of inability to achieve satisfactory fixing.

Moreover, the photofixing method has such a problem that the air in the vicinity of toner expands and the toner boils resulting in voids (whiting defects) which are minute printing defects, because the toner is subjected to instantaneous heating by the irradiation with light in the photofixing method. To address this problem, Japanese Unexamined Patent Publication (Kokai) No. 5-107805 discloses an attempt to prevent voids from occurring by controlling the softening point, the glass transition point and the acid value of a binder resin which is used as a major component of toner. However, this method is not effective in preventing voids from occurring when a color toner is used. In the case of a color toner, the binder resin is designed to have lower viscosity than that in the case of black toner for the purpose of smoothing the toner image, which leads to the generation of voids.

Moreover, since infrared absorbing compounds in common use such as aminium, diimonium and cyanine have N or S atoms in the molecules thereof and have strong tendency to be positively charged, it is difficult to make a negatively charged toner which is useful.

A proposal for preparing a negatively charged toner by adding a negative charge controlling agent has been made. For the negative charge controlling agent, for example, there are such materials as a calixarene compound described in Japanese Unexamined Patent Publication (Kokai) No. 2-201378, a zinc complex described in Japanese Unexamined Patent Publication (Kokai) No. 4-211691, a chromium complex described in Japanese Unexamined Patent Publication (Kokai) No. 57-141452, a chromium complex described in Japanese Unexamined Patent Publication (Kokai) No. 2-16916, a chromium compound described in Japanese Patent No. 2885238, and a boron complex described in Japanese Unexamined Patent Publication (Kokai) No. 2-48674. However, since the infrared absorbing agent compound and the charge controlling agent react with each other, during heating when manufacturing the toner, resulting in the loss of both the infrared ray absorbing power and the charging power of the toner thus manufactured, it is almost impossible at present to use both agents in a simple combination.

### SUMMARY OF THE INVENTION

Under these circumstances, the present invention has been completed. An object of the present invention is to provide an imaging color toner which allows use of the photofixing system for fixing images without forming voids, and is capable of achieving negative chargeability and color toner fixability in photofixing at the same time.

Another object of the present invention is to provide a color image forming method which allows use of the photofixing system for fixing images without forming voids, and is capable of achieving negative chargeability and color toner fixability in photofixing at the same time.

Still another object of the present invention is to provide a color image forming apparatus which allows use of the photofixing system for fixing images without forming voids, and is capable of achieving negative chargeability and color toner fixability in photofixing at the same time.

The objects described above and other objects of the present invention will become apparent from the following detailed description.

In an aspect of the present invention, there is provided an imaging color toner comprising at least a binder resin and a colorant, which is used in an imaging process employing a photofixing system, the imaging color toner further comprising a combination of:

a calixarene compound represented by the following formula (I):

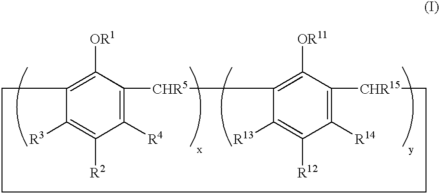

wherein R¹, R², R³, R⁴ and R⁵ may be the same or different and each represents a hydrogen atom, an alkyl group, a group of —(CH₂)mCOOR¹⁰ in which R¹⁰ represents a hydrogen atom or an alkyl group, and m represents a positive integer, a group of —N(R⁷)₂ in which R⁷ represents an oxygen atom, a hydrogen atom or an alkyl group, a group of —SO₃R⁸ in which R⁸ represents a hydrogen atom or an alkyl group, an aryl group or a group of —Si(CH₃)₃,

R¹, R¹², R¹³, R¹⁴ and R¹⁵ may be the same or different and each represents a hydrogen atom, an alkyl group, a group of —(CH₂)mCOOR²⁰ in which R²⁰ represents a hydrogen atom or an alkyl group, and m represents a positive integer, a group of —N(R¹⁷)₂ in which R¹⁷ represents an oxygen atom, a hydrogen atom or an alkyl group, a group of —SO₃R¹⁸ in which R¹⁸ represents a hydrogen atom or an alkyl group, an aryl group or a group of —Si(CH₃)₃, and

x and y each represents 0 or a positive integer, and

an infrared absorbing compound which shows a light absorption peak at a wavelength ranging from 700 to 1,000 nm.

In another aspect of the present invention, there is provided a method of forming a color image on a recording medium by means of an electrophotographic system which comprises the steps of forming an electrostatic latent image by image exposure, visualizing the electrostatic latent image by development, transferring the visualized image onto the recording medium and fixing the transferred image, wherein

a developing agent containing the color toner of the present invention is used in the step of developing the electrostatic latent image, and

a photofixing system is used at a light emission energy density ranging from 1.0 to 6.0 J/cm² in the step of fixing the transferred image after transferring the image visualized by using the developing agent onto the recording medium.

Furthermore, in a still another aspect of the present invention, there is provided an apparatus for forming a color image on a recording medium by means of an electrophotographic system, comprising an image exposing device for forming an electrostatic latent image, a developing device for visualizing the electrostatic latent image, an image transferring device for transferring the visualized image onto the recording medium, and an image fixing device for fixing the transferred image onto the recording medium, wherein

the developing device is loaded with a developing agent containing the color toner of the present invention, and

the image fixing device is provided with a photofixing device having a light emission energy density ranging from 1.0 to 6.0 J/cm².

### BRIEF DESCRIPTION OF THE DRAWINGS

FIG. 1 is a sectional view schematically showing a preferred example of an electrophotographic system for use in the image forming method employing a flash fixing system for fixing the toner, and

FIG. 2 is a light emission spectrum of Xenon light.

### DESCRIPTION OF THE PREFERRED EMBODIMENTS

The present invention can be basically applied to a wide variety of imaging processing including conventional electrophotographic processes and ionogaraphic processes. Thus, the present invention should not be limited to an electrophotographic process which will be described hereinafter. There is also no limitation to the developing method used in the electrophotographic process wherein the present invention is applied, and a proper developing method can be freely selected and employed for each application. In other words, according to the present invention, a developing agent most suitable for the developing method to be employed can be prepared and used for the particular application, while satisfying the requirements for the color toner of the present invention. Developing methods which can be employed in the present invention include both the two-component developing system and the one-component developing system that are widely used in the art.

In the two-component developing system, toner particles and carrier particles, that comprise magnetite, ferrite, iron powder, glass beads or such particles coated with a resin, are brought into contact with each other, with the toner being caused to deposit on the carrier particles by the use of friction charging, and the toner is directed to a portion of latent image thereby to develop the image. In this system, a developing agent is constituted by combining the toner and the carrier. The particle diameter of the carrier is typically within a range from 30 to 500 μm, while 0.5 to 10% by weight of the toner particles is mixed with the carrier particles. Methods employing this system include a magnetic brush development method.

The one-component developing system, which is also well known, is a variation of the two-component developing system wherein use of the carrier is eliminated. This method eliminates the need for mechanisms such as for toner concentration control, mixing and stirring because the carrier is not used, and also makes it possible to reduce the apparatus size. In the one-component developing system, a thin uniform film of toner is formed on a developing roller which is made of a metal and an image is developed by attracting the toner to a portion of a latent image. The toner particles deposited on the developing roller can be electrostatically charged by friction charging or electrostatic induction. In the case of one-component developing system employing friction charging, for example, a magnetic toner is used in BMT system and FEED system which involve contact, and nonmagnetic toner is used in touchdown system which involves contact. Details on the electrophotographic processes and the developing methods employed therein will be found in many publications dealing with the subject of electrophotographic system.

The electrophotographic color toner of the present invention may have a composition similar to that of the color toner used in the electrophotographic system of the prior art. That is, the color toner of the present invention may be generally constituted so as to include at least a binder resin and a colorant. While various developing methods are employed in the electrophotographic system as described above, the color toner of the present invention may be either a magnetic toner which has magnetism by itself or a nonmagnetic toner depending on the developing method employed in the intended electrophotographic processes.

In the electrophotographic color toner of the present invention, the binder resin used as the base material is not specifically limited, but is preferably a binder resin made of a natural or synthetic polymer substance. Preferred examples of the binder resin include polyester resin, styrene-acrylic resin, styrene resin, acrylic resin, polyetherpolyol resin, phenol resin, silicone resin, and epoxy resin. In the color toner of the present invention, a polyester resin can be used most advantageously. These binder resins may be used alone, or two or more resins may be used in combination or used in the form of a composite. A linear polyester resin and a polyester resin containing a crosslinking component may be used in combination.

The polyester resin and the other binder resin can have different molecular weights according to the desired effect. The molecular weight (weight-average molecular weight) of the binder resin to work the present invention is usually within a range from about 1,000 to 30,000, and preferably from about 2,000 to 15,000. The binder resin has a glass transition temperature of about 55 to 70° C. and a softening point of about 70 to 190° C.

In the color toner of the present invention, the colorant to be dispersed in the binder resin includes various publicly known dyes and pigments which can be arbitrarily selected and used. Preferred examples of the colorant include, but are not limited to, carbon black, lamp black, iron black, ultramarine blue, nigrosin dye, aniline blue, chalco oil blue, DuPont oil red, quinoline yellow, methylene blue cloride, phthalocyanine blue, phthalocyanine green, hansa yellow, rhodamine 6C lake, chrome yellow, quinacridon, benzidine yellow, malachite green, malachite green hexanoate, oil black, azo oil black, rose bengal, monoazo pigment, disazo pigment, and trisazo pigment. These colorants may be used alone, or used in combination to obtain a desired toner color.

The content of the toner in the colorant can vary according to the desired results, but is usually within a range from 0.1 to 20 parts by weight, and preferably from 0.5 to 10 parts by weight, based on 100 parts by weight of the toner in view of the coloring force of printing, shape retention of the toner and scattering of the toner in order to obtain the best toner characteristics.

As described above, it is essential to use at least a calixarene compound and an infrared absorbing compound in combination with the binder resin and the colorant, in the electrophotographic color toner of the present invention.

As described above, the calixarene compound is a calixarene compound represented by the formula (I) described above.

Describing in more detail, in the formula (I), R¹, R², R³, R⁴ and R⁵ may be the same or different and each represents a hydrogen atom, an alkyl group, preferably an alkyl group having 1 to 12 carbon atoms, a group of —(CH₂)mCOOR¹⁰ in which R¹⁰ represents a hydrogen atom or an alkyl group, preferably a lower alkyl group having 1 to 5 carbon atoms, and m represents an integer of 1 to 3, a group of —N(R⁷)₂ in which R⁷ represents an oxygen atom, a hydrogen atom or an alkyl group, preferably a lower alkyl group, a group of —SO₃R⁸ in which R⁸ represents a hydrogen atom or an alkyl group, preferably a lower alkyl group, an aryl group, preferably a substituted or non-substituted phenyl group, or a group of —Si(CH₃)₃, R¹¹, R¹², R¹³, R¹⁴ and R¹⁵ may be the same or different and each represents a hydrogen atom, an alkyl group, a group of —(CH₂)mCOOR²⁰ in which R²⁰ represents a hydrogen atom or an alkyl group, and m represents an integer of 1 to 3, a group of —N(R¹⁷)₂ in which R¹⁷ represents an oxygen atom, a hydrogen atom or an alkyl group, a group of —SO₃R¹⁸ in which R¹⁸ represents a hydrogen atom or an alkyl group, an aryl group or a group of —Si(CH₃)₃, that is, the substituents R¹¹, R¹², R¹³, R¹⁴ and R¹⁵ each can represent the same substituent as that of R¹, R², R³, R⁴ and R⁵, and

x and y each represents 0 or a positive integer, preferably x represents an integer of 4 to 8 and y represents an integer of 0 to 4.

Preferred examples of the calixarene compound to work the present invention include, but are not limited to, the following compounds of the general formulas.

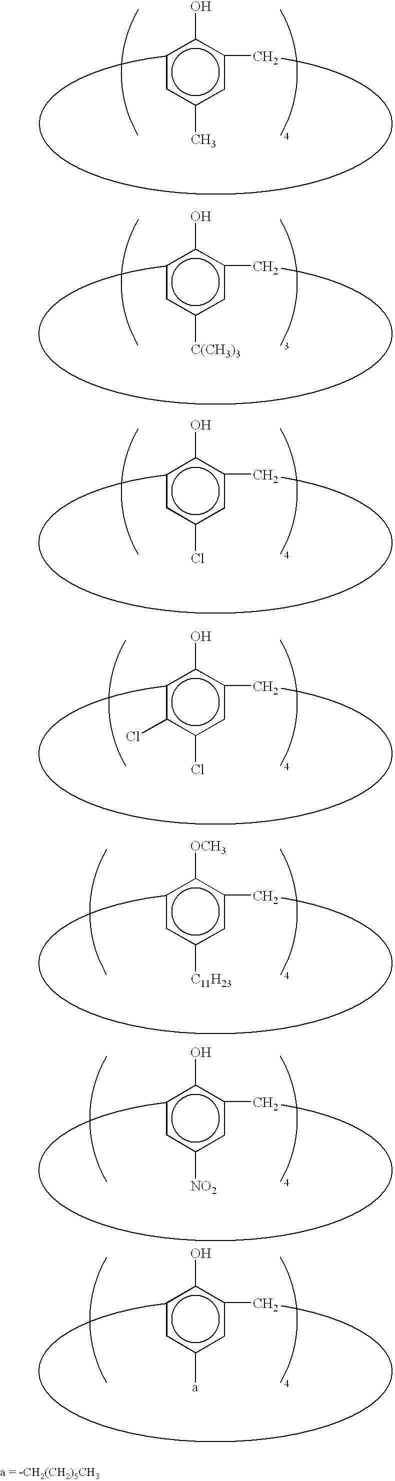

These calixarene compounds can easily be synthesized according to the procedures described in the literature and, for example, in J. Am. Chem. Soc., 103, 3782-3792 (1981), Pure & Appl. Chem., Vol. 58, No. 11, 1523-1528 (1985), Tetrahedron Letters, Vol. 26, No. 28, 3343-3344 (1985), and Gendai Kagaku (Modern Chemistry), 182, 14-23 (1986).

The calixarene compound is preferably incorporated in an amount within a range from 0.1 to 10 parts by weight, and more preferably from 0.5 to 2 parts by weight, based on 100 parts by weight of the toner. When the amount of the calixarene compound is larger than 10 parts by weight, the infrared absorbing compound is slightly decomposed, resulting in poor fixability. On the other hand, when the amount of the calixarene compound is smaller than 0.1 parts by weight, the chargeability effect is not exerted.

As the charge controlling agent, a well-known charge controlling agent can be added, together with the calixarene compound, as far as an adverse influence is not exerted on charging. Examples of well-known charge controlling agents include nigrosine dye, quaternary ammonium salt, amino group-containing polymer, metal-containing azo dye, complex compound of salicylic acid, phenol compound, azochrome compound, and azo zinc compound. These additional charge controlling agents are usually used in the amount of 1% by weight or less based on the total amount of the charge controlling agent.

The infrared absorbing agent used in combination with the charge controlling agent is an infrared absorbing compound which shows a light absorption peak at a wavelength ranging from 700 to 1000 nm, though it varies with the wavelength of the light used in photofixing. Preferred examples of the infrared absorbing compound capable of showing the light absorption peak include cyanine, anthaquinone, phthalocyanine, naphthalocyanine, polymethine, nickel complex, aminium, diimonium, tin oxide, ytterbium oxide, ytterbium phosphate, and cerium oxide. These infrared absorbing compounds may be used alone or two or more infrared absorbing compounds may be used in combination.

In the practice of the present invention, among these infrared absorbing compounds, phthalocyanine or naphthalocyanine can be used alone, or in combination, particularly advantageously. In such a case, the other infrared absorbing compound described above can be used in such an amount that an adverse influence is not exerted on the chargeability.

The amount of the toner in the infrared absorbing compound can vary widely according to the desired results, but is preferably within a range from 0.01 to 5 parts by weight, and more preferably from 0.1 to 1 parts by weight, based on 100 parts by weight of the toner. When the amount of the toner is smaller than 0.01 parts by weight, the toner cannot be fixed even in case of good design. On the other hand, if the amount of the toner is larger than 5 parts by weight, if the charge controlling agent is decomposed, thus making it impossible to obtain a desired charge level.

The electrophotographic color toner of the present invention can arbitrarily contain various conventional additives.

For the purpose of improving the fluidity, the color toner of the present invention can be mixed with fine white inorganic powders. The amount of fine inorganic powders to be mixed with the toner is usually within a range from 0.01 to 5 parts by weight, and preferably from 0.01 to 2.0 parts by weight, based on 100 parts by weight of the toner. Examples of fine inorganic powders include fine powders of silica, titanium oxide, barium titanate, magnesium titanate, calcium titanate, strontium titanate, zinc oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. Among these fine powders, fine silica powders are particularly preferred. Publicly known materials such as silica, titanium, fine resin powders and alumina can be used in combination. As the cleaning active agent, for example, fine powders of metal salts of higher fatty acid such as zinc stearate, etc. and fluorine polymeric substances may be added.

Well-known waxes such as polyethylene, polypropylene, ester wax, carnauba, Fisher-Tropsch wax, paraffin wax, and rice wax can be used in combination.

The electrophotographic color toner of the present invention can be prepared acording to various procedures using the toner components described above as the starting materials. For example, the color toner of the present invention can be made by employing a known method such as mechanical grinding and classifying process where resin blocks with a colorant or the like dispersed therein are ground and classified, or a polymerization method where a monomer is polymerized while mixing a colorant or the like therein thereby forming fine particles. The color toner of the present invention is preferably made by the mechanical grinding method and advantageously in a procedure as described below.

(1) Mixing of Materials

A binder resin, a colorant, a charge controlling agent, an infrared absorbing compound and the like are weighed and mixed uniformly in a powder mixing machine. For the powder mixing machine, for example, a ball mill or the like can be used. The colorant, the charge controlling agent, etc. are dispersed uniformly in the resin binder.

(2) Melt Kneading

The mixture thus obtained is heated to melting and is kneaded using a screw extruder, roll mill, kneader or the like. This turns the colorant particles into fine particles and causes the agents to be dispersed uniformly.

(3) Solidification with Cooling

After the completion of the kneading, the kneaded mixture is solidified with cooling.

(4) Grinding

The solidified mixture is first ground into coarse particles with a coarse grinder such as a hammer mill or a cutter mill, and then ground into fine powder with a finer grinder such as a jet mill.

(5) Classification

The fine powder made by fine grinding is classified so as to remove particles which are too small and result in lower fluidity of the toner and scattering of the toner, and particles which are too larger and result in degradation of image quality. For the classifier, for example, a wind classifier that utilizes centrifugal force may be used to obtain the desired fine spherical particles of the toner.

(6) Surface Treatment

In the last step, the toner particles may be coated with hydrophobic silica or titanium oxide, with another additive added as required, for the purpose of improving the fluidity of the toner. A high speed flow mixer may be used in the surface treatment.

The color image forming method of the present invention includes the steps of forming an electrostatic latent image by image exposure, visualizing the electrostatic latent image by development, transferring the visualized image onto the recording medium and fixing the transferred image, as described previously, while a developing agent containing the color toner of the present invention is used, unlike a conventional method.

Also according to the present invention, in the step of transferring the image which has been visualized by the use of the developing agent onto the recording medium and then fixing the image, a photofixing system is employed to fix the toner. Light can be advantageously used in the photofixation of the transferred toner image. The light may have wavelengths selected from a broad region reaching the near infrared as well as the visible region, in accordance with the specifications of the flash fixing device to be used. A Xenon lamp can be used to generate the light which can efficiently fix the toner. The light intensity of the Xenon lamp is preferably within a range from 1.0 to 6.0 J/cm², in terms of energy density per unit area, per single flash. An energy density of light less than 1.0 J/cm² is unable to fix the toner and an energy density higher than 6.0 J/cm² may burn the toner and/or paper. The energy density of light S J/cm² is given as follows.

S=((1/2)×C×V²)/(u×l)/(n×f)

where n is the number of lamps, f is the lighting frequency (Hz), V is the input voltage, C is the capacitance of a capacitor (μF), u is the traveling speed of the process (mm/s)and 1 is the printing width (mm).

Although duration of one flash cycle of the light may be set within a wide range according to the energy density of the light, it is preferably in a range from 500 to 3,000 μs. Too short a flash cycle of the light may be unable to melt the toner at a rate sufficient to obtain satisfactory fixing of the toner. Too long a flashing cycle of the light may, on the other hand, cause overheating of the toner which is fixed on the recording medium.

More specifically, the color image forming method of the present invention may be applied similarly to the image forming method of the prior art, except for the difference described above. By way of a preferable example, formation of an electrostatic latent image by image exposure can be carried out, after uniformly charging the surface of a photoconductive insulator such as a photosensitive drum with positive or negative electrostatic charge, by partially erasing the electrostatic charge deposited on the insulator by irradiating the photoconductive insulator with light in the pattern of the image with any of various means, thereby leaving the electrostatic latent image behind. For example, the surface charge can be erased from particular portions by irradiating with laser beam, so as to form the electrostatic latent image on the photoconductive insulator according to the image information.

The electrostatic latent image thus formed is then visualized by development. This can be done by depositing a fine powder of the developing agent, which includes the toner of the present invention, on the latent image portion where the electrostatic charge remains on the photoconductive insulator.

After the developing step, the visualized image is transferred onto the recording medium. This can be generally done by electrostatically transferring the toner image onto the recording medium such as recording paper.

Finally, the toner image, transferred in the transfer step described above, is molten and fixed on the recording medium by the flash fixing method according to the present invention. An intended duplicate (print or the like) is obtained through the series of processes described above.

The method of forming color images based on electrophotography is well known in this technical field and, accordingly, a description thereof will be omitted herein.

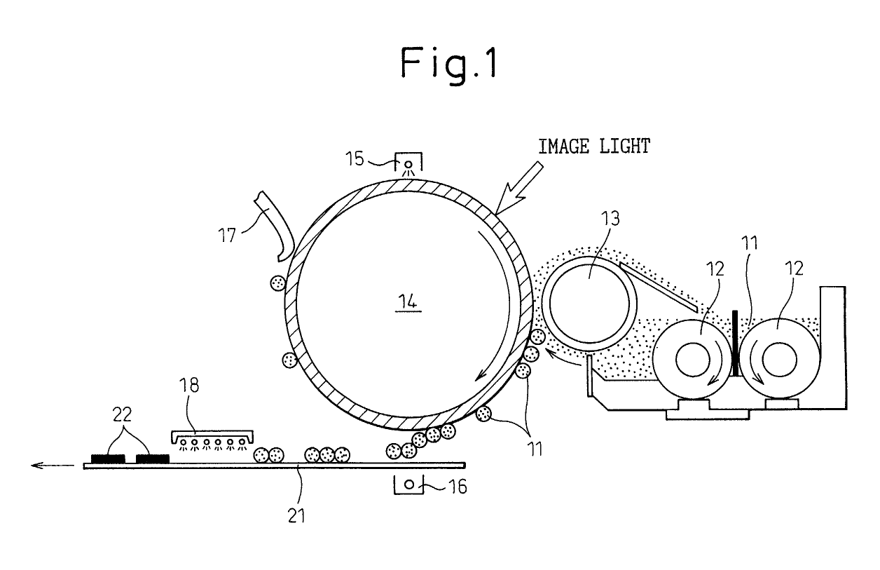

The color image forming apparatus of the present invention, typically the electrophotographic apparatus, is also well known in this technical field and accordingly description thereof will be omitted herein. For reference, an example of electrophotographic apparatus which can be advantageously used in the present invention is shown in FIG. 1.

In the electrophotographic apparatus shown in FIG. 1, a developing agent 11 prepared by mixing the color toner of the present invention and a carrier is stirred with a stirring screw 12 so as to effect friction charging. The developing agent 11 which is charged by friction is guided through a predetermined circulation path via a developing roller 13 to reach a photosensitive drum 14. The photosensitive drum 14 may be constituted from a photosensitive material which has photoconductivity and is, for example, an organic photosensitive material such as polysilane, phthalocyanine, phthalopolymethine or an inorganic photosensitive material such as selenium and amorphous silicon, or an insulating material, depending on the method of forming the latent image. A photosensitive material made of amorphous silicon is particularly preferable in view of the long life thereof.

The surface of the photosensitive drum 14 which has received the developing agent 11 transferred thereto is electrostatically charged by a preliminary charger 15 located behind the drum in the rotating direction thereof, while the electrostatic latent image is formed thereon by the image light, i.e., a light applied by an exposure device (not shown) according to the image. The preliminary charger 15 may comprise a corona discharging mechanism such as a corotron or a scorotron, or a contact charging mechanism such as brush charger. The exposure device may be constituted by using various optical systems as the light source such as a laser optical system, an LED optical system or a liquid crystal optical system. Thus the developing agent 11 which has been charged and transferred to the photosensitive drum 14 is deposited on the drum surface in the area of electrostatic latent image, thereby forming the visualized toner image.

The toner image 11 formed on the photosensitive drum 14 is moved onto the transfer section 16 and is transferred onto a recording medium (paper, film, etc.) 21. The transfer section 16 may have various constitutions depending on the type of force used in the transfer process, such as electrostatic force, mechanical force or viscous force. If electrostatic force is used, for example, a corona transferring device, a roll transferring device, a belt transferring device or the like can be employed.

The recording medium 21 is guided in the direction of the arrow, so that the toner image is fixed thereon below the flash fixing device 18. The toner image on the recording medium 21 is heated by the flash fixing device 18 so as to melt and penetrate into the recording medium 21 thereby to be fixed. When the fixing step is completed, a fixed image 22 is obtained.

Toner which is left without being used in the transfer step in the toner image 11 on the photosensitive druml4 is discharged by a discharger (not shown) and removed from the surface of the photosensitive druml4 by a cleaning device (a blade in the case shown in the drawing) 17. The cleaning device may be, besides a blade, a magnetic brush cleaner, an electrostatic brush cleaner or a magnetic roller cleaner.

### EXAMPLES

The following Examples further illustrate the present invention in detail. It goes without saying that the present invention is not limited to these Examples.

### Preparation Examples

(1) Preparation of Carrier

Magnetite particles of 60 Am in diameter, to be used as the cores of carrier particles, were coated with an acrylic resin (BR-85 manufactured by Mitsubishi Rayon Co., Ltd.) in a fluidized bed and dried. The amount of the coating material is 2% by weight based on the amount of core material of the carrier. A magnetite carrier coated with the acrylic resin was thus obtained.

(2) Preparation of Color Toner

Color toners having different compositions shown in Table 2 and Table 3 were prepared. In the tables, “polyester” is FN119 (trade name) manufactured by Kao Corporation of which the mean molecular weight is 7.5×10⁴, the glass transition point is 63° C., the softening point is 115° C. and the acid value is 20. The infrared absorbing compounds are summarized in Table 1.

Preparation of Toner SCY-1

Components of the toner listed in Table 2 were prepared in each amount (parts by weight) described in Table 2. All the components of the toner were charged in a Henschel mixer for preliminary mixing. Then the mixture was molten and kneaded in an extruder. After cooling the mixture to solidify it, the solid mixture was ground by a hammer mill and then ground into fine powder in a jet mill. The fine powder thus obtained was classified by an air flow classifier, thereby to obtain fine particles, colored yellow, having a volume-average particle diameter of 8.5 μm. To the fine particles of toner thus obtained, 0.5 parts by weight of hydrophobic fine silica particles (H3004 manufactured by Clariant Japan Co., Ltd.) were externally added in the Henschel mixer.

Preparation of Toners SCY-2 to SCY-22

In the same manner as in case of the preparation of the toner SCY-1, except that the materials and each amount thereof were changed to those described in Table 2 and Table 3 described below, toners SCY-2 to SCY-22 were prepared. After the colored fine particles having a volume-average particle diameter of 8.5 μm were obtained, external additives were added.

### Examples 1 to 8 and Comparative Examples 1 to 18

Toner SCY-1 and toners SCY-2 to SCY-22 prepared as described above were used in printing tests employing the flash fixing system.

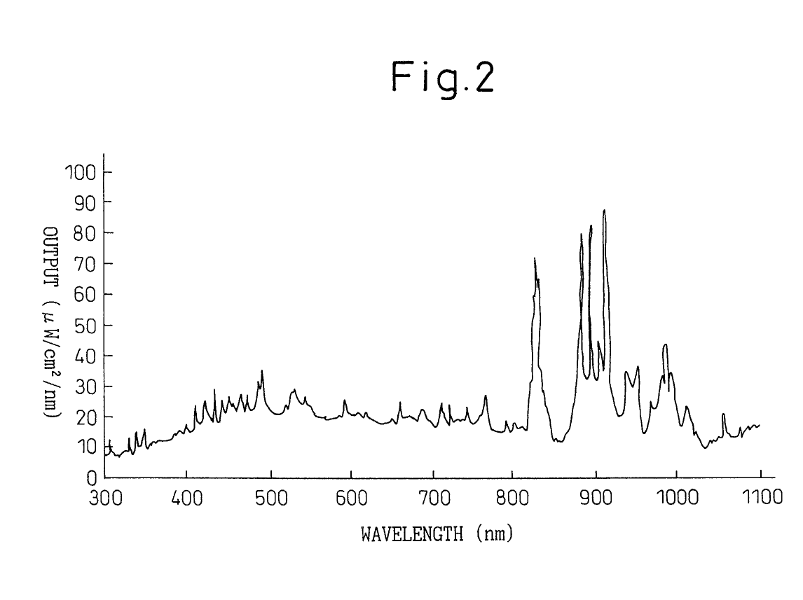

5% by weight of each of the toners described above was mixed with 95% by weight of the carrier prepared as described above, thereby to make a developing agent. The developing agent was set in a high sped printing machine (modification of “PS2160” manufactured by Fujitsu Corp.) having a xenon lamp as the fixing light source. Then lines were printed at a process speed of 20,000 lines per minute on plain paper, used as the recording medium, while changing the energy of the fixing light as shown in Table 2 and Table 3. The light emitted by the xenon lamp had the spectrum schematically shown in FIG. 2, and the duration of one flash cycle was 1000 μs. Prints thus obtained were evaluated for the following performance:

(1) Fixation % of toner

(2) Fixability

(3) Occurrence of voids

(4) Burning of paper

(5) Fogging, chargeability

(1) Measurement of fixation % of toner

The optical density (Status A density) of the lines printed on the paper was measured first. Then after lightly sticking an adhesive tape (Scotch™ Mending Tape manufactured by Sumitomo 3M) on the lines printed on the same paper, a cylinder made of steel 100 mm in diameter and 20 mm in width was rolled over the tape in contact therewith, and then the tape was pulled off the paper. Then, the optical density of the lines printed on the paper from which the tape was removed was measured again. Percentage of the optical density after removing the tape to the optical density before removing the tape (100%) was calculated and recorded as the fixation (%) of toner.

(2) Fixability

The fixability of each toner was rated from the fixation (%) of the toner according to the following criteria.

| | |
|---|---|
| Below 70% | X |
| From 70% to below 80% | Δ |
| From 80% to below 90% | ◯ |
| 90% or higher | ⊚ |

Fixing rate of 80% or higher means that the toner has practically useful fixability.

(3) Evaluation of Voids (Whiting Defect)

Lines printed on the paper were observed with an optical microscope, to visually determine whether a whiting defect was generated or not. A print without whiting defect was rated as ◯, a print having few whiting defects which can be permitted in practice was rated as A, and a print having whiting defects which are not practically permissible was rated as ×.

(4) Evaluation of Paper Burning

In a situation of flashing failure due to jamming of paper, it was visually checked to see whether the paper was burned at a portion where the light was applied three times repeatedly. A print without paper burning was rated as ◯, a print having slight burning which can be permitted in practice was rated as A, and a print having paper burning which was not practically permissible was rated as ×.

(5) Evaluation of Fogging and Chargeability

Amount of charge given to the surface of the printing material was measured in the early stage of printing and after printing five million sheets of paper. Then the prints were checked to see whether fogging (stain on the background) occurred or not. Print without fogging was rated as ◯, and print having fogging which was not practically permissible was rated as ×. The results of evaluation show that charging is required to be in a range from −15μC/g to −30 μC/g in the early stage of printing and after printing five million sheets of paper, in order to prevent fogging.

TABLE 1

| | | | Maximum absorption | Molecular absorption |
|---|---|---|---|---|
| Infrared absorber | Article number | Manufacturer | wavelength (nm) | coefficient (ε) |
| Anthraquinone | IR-750 | NIPPON KAYAKU | 755 | 17500 |
| | | CO., LTD. | | |
| Polymethine | PS-102 | NIPPON KAYAKU | 820 | 167000 |
| | | CO., LTD. | | |
| Cyanine | FT-10 | NIPPON KAYAKU | 845 | 235000 |
| | | CO., LTD. | | |
| Phthalocyanine | IR-3 | NIPPON SHOKUBAI | 850 | 48000 |
| | | CO., LTD. | | |
| Nickel complex | SIR-128 | Mitsui Chemicals | 855 | 60000 |
| Naphthalocyanine | YKR-5010 | Yamamoto Chemicals | 880 | 91200 |
| | | Inc. | | |
| Aminium | IRG-005 | NIPPON KAYAKU | 948 | 23900 |
| | | CO., LTD. | | |
| Ytterbium oxide | UU-HP | SHIN-ETSU CHEMICAL | 980 | — |
| | | CO., LTD. | | |
| Diimonium | IRG-023 | NIPPON KAYAKU | 1090 | 105000 |
| | | CO., LTD. | | |
| Tin oxide | TL-30S | CATALYSTS & | 1095 | — |
| | | CHEMICALS IND. | | |
| | | CO., LTD. | | |

TABLE 2

| | | Comp. | Comp. | Comp. | | Comp. | Comp. | Comp. |
|---|---|---|---|---|---|---|---|---|
| | | Example | Example | Example | Example | Example | Example | Example |
| | | 1 | 2 | 3 | 1 | 4 | 5 | 6 |
| Components | Name | SCY-1 | SCY-2 | SCY-3 | SCY-4 | SCY-5 | SCY-6 | SCY-7 |
| Pigment | 3RS (IRGALITE, Ciba Speciality) | 5.0 | 5.0 | 5.0 | 5.0 | 5.0 | 5.0 | 5.0 |
| Binder | Polyester | 93.0 | 93.0 | 93.0 | 93.0 | 93.0 | 93.0 | 93.0 |
| Charge | CCA-100 (chromium compound, CHUO | 1.0 | | | | | | |
| controlling | SYNTHETIC CHEMICALS CO., LTD.) | | | | | | | |
| agent | E-81 (chromium complex, Orient Chemicals) | | 1.0 | | | | | |
| | E-84 (zinc complex, Orient Chemicals) | | | 1.0 | | | | |
| | Calixarene 1 | | | | 1.0 | | | |
| | TN105 (Hodogaya Chemical Co., Ltd.) | | | | | 1.0 | | |
| | LR147 (boron compound, Japan Carlit Co., Ltd.) | | | | | | 1.0 | |
| | P-51 (quaternary ammonium salt, Orient Chemicals) | | | | | | | 1.0 |
| Infrared | IR-750 | | | | | | | |
| absorber | PS-102 | | | | | | | |
| | FT-10 | | | | | | | |
| | IR-3 | | | | | | | |
| | SIR-128 | | | | | | | |
| | YKR-5010 | 0.5 | 0.5 | 0.5 | 0.5 | 0.5 | 0.5 | 0.5 |
| | IRG-005 | | | | | | | |
| | IRG-023 | | | | | | | |
| Wax | NP105 (Mitsui Chemicals) | 0.5 | 0.5 | 0.5 | 0.5 | 0.5 | 0.5 | 0.5 |
| External | H3004 (Clariant) | 0.5 | 0.5 | 0.5 | 0.5 | 0.5 | 0.5 | 0.5 |
| additive | | | | | | | | |
| Evaluation | Fixation (%) | 91.0 | 92.0 | 90.0 | 89.0 | 89.0 | 92.0 | 90.0 |
| | Judgment of fixability | ⊚ | ⊚ | ⊚ | ◯ | ◯ | ◯ | ◯ |
| | Occurrence of voids | ◯ | ◯ | ◯ | ◯ | ◯ | ◯ | ◯ |
| | Paper burning | ◯ | ◯ | ◯ | ◯ | ◯ | ◯ | ◯ |
| | Photofixing energy (J/cm²) | 2.2 | 2.2 | 2.2 | 2.2 | 2.2 | 2.2 | 2.2 |
| | Initial charge amount (−μC/g) | 21.4 | 20.6 | 11.6 | 20.4 | 14.6 | 10.1 | 10.2 |
| | Charge amount after printing 5,000,000 sheets | 10.2 | 9.8 | 2.3 | 21.5 | 2.3 | 1.3 | 1.2 |
| | (−μC/g) | | | | | | | |
| | Fogging | × | × | × | ◯ | × | × | × |
| | | Comp. | Comp. | Comp. | | Comp. | Comp. | Comp. |
| | | Example | Example | Example | Example | Example | Example | Example |
| | | 7 | 8 | 9 | 2 | 10 | 11 | 12 |
| Components | Name | SCY-8 | SCY-9 | SCY-10 | SCY-11 | SCY-12 | SCY-13 | SCY-14 |
| Pigment | 3RS (IRGALITE, Ciba Speciality) | 5.0 | 5.0 | 5.0 | 5.0 | 5.0 | 6.0 | 7.0 |
| Binder | Polyester | 93.0 | 93.0 | 93.0 | 93.0 | 93.0 | 93.0 | 93.0 |
| Charge | CCA-100 (chromium compound, CHUO | | | | | | | |
| controlling | SYNTHETIC CHEMICALS CO., LTD.) | | | | | | | |
| agent | E-81 (chromium complex, Orient Chemicals) | | | | | | | |
| | E-84 (zinc complex, Orient Chemicals) | | | | | | | |
| | Calixarene 1 | 1.0 | 1.0 | 1.0 | 1.0 | 1.0 | 1.0 | 1.0 |
| | TN105 (Hodogaya Chemical Co., Ltd.) | | | | | | | |
| | LR147 (boron compound, Japan Carlit Co., Ltd.) | | | | | | | |
| | P-51 (quaternary axnmonium salt, Orient | | | | | | | |
| | Chemicals) | | | | | | | |
| Infrared | IR-750 | 0.5 | | | | | | |
| absorber | PS-102 | | 0.5 | | | | | |
| | FT-10 | | | 0.5 | | | | |
| | IR-3 | | | | 0.5 | | | |
| | SIR-128 | | | | | 0.5 | | |
| | YKR-5010 | | | | | | 0.5 | |
| | IRG-005 | | | | | | | 0.5 |
| | IRG-023 | 0.5 | 0.5 | 0.5 | 0.5 | 0.5 | 0.5 | 0.5 |
| Wax | NP105 (Mitsui Chemicals) | 0.5 | 0.5 | 0.5 | 0.5 | 0.5 | 0.5 | 0.5 |
| External | H3004 (Clariant) | | | | | | | |
| additive | | | | | | | | |
| Evaluation | Fixation (%) | 84.0 | 85.0 | 86.0 | 82.0 | 81.0 | 82.0 | 82.0 |
| | Judgment of fixability | ◯ | ◯ | ◯ | ◯ | ◯ | ◯ | ◯ |
| | Occurrence of voids | ◯ | ◯ | ◯ | ◯ | ◯ | ◯ | ◯ |
| | Paper burning | ◯ | ◯ | ◯ | ◯ | ◯ | ◯ | ◯ |
| | Photofixing energy (J/cm²) | 2.2 | 2.2 | 2.2 | 2.2 | 2.2 | 2.2 | 2.2 |
| | Initial charge amount (−μC/g) | 18.9 | 19.6 | 18.3 | 17.9 | 22.6 | 23.6 | 19.9 |
| | Charge amount after printing 5,000,000 sheets | 3.6 | 4.5 | 6.3 | 18.2 | 2.3 | 2.3 | 2.6 |
| | (−μC/g) | | | | | | | |
| | Fogging | × | × | × | ◯ | × | × | × |

TABLE 3

| | | Comp. | | | Comp. | Comp. | |
|---|---|---|---|---|---|---|---|
| | | Example | Example | Example | Example | Example | Example |
| | | 13 | 3 | 4 | 14 | 15 | 5 |
| | Name | SCY-15 | SCY-16 | SCY-17 | SCY-18 | SCY-19 | SCY-20 |
| Pigment | 3RS (IRGALITE, Ciba Speciality) | 5.0 | 5.0 | 5.0 | 5.0 | 5.0 | 5.0 |
| Binder | Polyester | 94.0 | 93.9 | 84.0 | 79.0 | 93.5 | 93.5 |
| Charge | CCA-100 (chromium compound, CHUO SYNTHETIC | | | | | | |
| controlling | CHEMICALS CO., LTD.) | | | | | | |
| agent | E-81 (chromium complex, Orient Chemicals) | | | | | | |
| | E-84 (zinc complex, Orient Chemicals) | | | | | | |
| | Calixarene 1 | 0.01 | 0.1 | 10.0 | 15.0 | 1.0 | 1.0 |
| | TN105 (Hodogaya Chemical Co., Ltd.) | | | | | | |
| | LR147 (boron compound, Japan Carlit Co., Ltd.) | | | | | | |
| | P-51 (quaternary ammonium salt, Orient Chemicals) | | | | | | |
| Infrared | IR-750 | | | | | | |
| absorber | PS-102 | | | | | | |
| | FT-10 | | | | | | |
| | IR-3 | | | | | | |
| | SIR-128 | | | | | | |
| | YKR-5010 | 0.5 | 0.5 | 0.5 | 0.5 | 0.005 | 0.05 |
| | IRG-005 | | | | | | |
| | IRG-023 | | | | | | |
| Wax | NP105 (Mitsui Chemicals) | 0.5 | 0.5 | 0.5 | 0.5 | 0.5 | 0.5 |
| External | H3004 (Clariant) | 0.5 | 0.5 | 0.5 | 0.5 | 0.5 | 0.5 |
| additive | | | | | | | |
| Evaluation | Fixation (%) | 91.0 | 92.0 | 90.0 | 89.0 | 65.0 | 82.0 |
| | Judgment of fixability | ⊚ | ⊚ | ⊚ | ◯ | × | ◯ |
| | Occurrence of voids | ◯ | ◯ | ◯ | ◯ | ◯ | ◯ |
| | Paper burning | ◯ | ◯ | ◯ | ◯ | ◯ | ◯ |
| | Photofixing energy (J/cm²) | 2.2 | 2.2 | 2.2 | 2.2 | 2.2 | 2.2 |
| | Initial charge amount (−μC/g) | 6.4 | 15.6 | 16.9 | 5.6 | 20.1 | 22.2 |
| | Charge amount after printing 5,000,000 sheets | 5.2 | 16.8 | 17.5 | 1.6 | 21.0 | 21.6 |
| | (−μC/g) | | | | | | |
| | Fogging | × | ◯ | ◯ | × | ◯ | ◯ |
| | | | Comp. | Comp. | | | Comp. |
| | | Example | Example | Example | Example | Example | Example |
| | | 6 | 16 | 17 | 7 | 8 | 18 |
| Components | Name | SCY-21 | SCY-22 | SCY-4 | SCY-4 | SCY-4 | SCY-4 |
| Pigment | 3RS (IRGALITE, Ciba Speciality) | 5.0 | 5.0 | 5.0 | 5.0 | 5.0 | 5.0 |
| Binder | Polyester | 88.5 | 83.5 | 93.0 | 93.0 | 93.0 | 93.0 |
| Charge | CCA-100 (chromium compound, CHUO SYNTHETIC | | | | | | |
| controlling | CHEMICALS CO., LTD.) | | | | | | |
| agent | E-81 (chromium complex, Orient Chemicals) | | | | | | |
| | E-84 (zinc complex, Orient Chemicals) | | | | | | |
| | Calixarene 1 | 1.0 | 1.0 | 1.0 | 1.0 | 1.0 | 1.0 |
| | TN105 (Hodogaya Chemical Co., Ltd.) | | | | | | |
| | LR147 (boron compound, Japan Carlit Co., Ltd.) | | | | | | |
| | P-51 (quaternary ammonium salt, Orient Chemicals) | | | | | | |
| Infrared | IR-750 | | | | | | |
| absorber | PS-102 | | | | | | |
| | FT-10 | | | | | | |
| | IR-3 | | | | | | |
| | SIR-128 | | | | | | |
| | YKR-5010 | 5.0 | 10.0 | 0.5 | 0.5 | 0.5 | 0.5 |
| | IRG-005 | | | | | | |
| | IRG-023 | | | | | | |
| Wax | NP105 (Mitsui Chemicals) | 0.5 | 0.5 | 0.5 | 0.5 | 0.5 | 0.5 |
| External | H3004 (Clariant) | 0.5 | 0.5 | 0.5 | 0.5 | 0.5 | 0.5 |
| additive | | | | | | | |
| Evaluation | Fixation (%) | 99.0 | 100.0 | 59.0 | 93.0 | 95.0 | 100.0 |
| | Judgment of fixability | ◯ | ◯ | × | ◯ | ◯ | ◯ |
| | Occurrence of voids | ◯ | ◯ | ◯ | ◯ | ◯ | × |
| | Paper burning | ◯ | ◯ | ◯ | ◯ | ◯ | × |
| | Photofixing energy (J/cm²) | 2.2 | 2.2 | 0.5 | 4.0 | 6.0 | 10.0 |
| | Initial charge amount (−μC/g) | 20.2 | 5.6 | 20.4 | 20.4 | 20.4 | 20.4 |
| | Charge amount after printing 5,000,000 sheets | 20.3 | 3.6 | 21.5 | 21.5 | 21.5 | 21.5 |
| | (−μC/g) | | | | | | |
| | Fogging | ◯ | × | ◯ | ◯ | ◯ | ◯ |

As will be understood from the results of the evaluation shown in Table 2 and Table 3, satisfactory performance can be ensured both in fixability and chargeability by using naphthalocyanine or phthalocyanine as the infrared absorbing agent and using the calixarene compound as the charge controlling agent. While dependency on the quantity of additive added was investigated in Examples 3 to 5 and Comparative Examples 13 to 16, satisfactory result can be achieved when 0.1 to 10 parts by weight of the calixarene compound and 0.01 to 5 parts by weight of phthalocyanine or naphthalocyanine are added to 100 parts by weight of the toner. Comparison of Examples 7 and 8 as well as Comparative Examples 17 and 18 shows that an energy density in a range from 1.0 to 6.0 J/cm² is effective in flash fixing.

According to the present invention, as described above, there can be provided an electrophotographic color toner which allows use of a photofixing system for fixing images, without forming voids, and is capable of achieving negative chargeability and color toner fixability in photofixing at the same time.

Also according to the present invention, there can be provided a color image forming method and an color image forming apparatus, which allow it to effectively use the color toner of the present invention and fully achieve the effects thereof.

1. A color imaging toner, comprising at least a binder resin and a colorant, which is used in an imaging process employing a photofixing system, said imaging color toner further comprising a combination of:
a calixarene compound represented by the following formula (I): 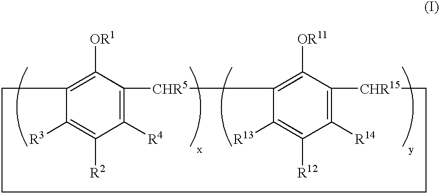
wherein R¹, R², R³, R⁴ and R⁵ may be the same or different and each represents a hydrogen atom, an alkyl group, a group of —(CH₂)mCOOR¹⁰ in which R¹⁰ represents a hydrogen atom or an alkyl group, and m represents a positive integer, a group of —N(R⁷)₂ in which R⁷ represents an oxygen atom, a hydrogen atom or an alkyl group, a group of —SO₃R⁸ in which R⁸ represents a hydrogen atom or an alkyl group, an aryl group or a group of —Si(CH₃)₃,
R¹¹, R¹², R¹³, R¹⁴ and R¹⁵ may be the same or different and each represents a hydrogen atom, an alkyl group, a group of —(CH₂)mCOOR²⁰ in which R²⁰ represents a hydrogen atom or an alkyl group, and m represents a positive integer, a group of —N(R¹⁷)₂ in which R¹⁷ represents an oxygen atom, a hydrogen atom or an alkyl group, a group of —SO₃R¹⁸ in which R¹⁸ represents a hydrogen atom or an alkyl group, an aryl group or a group of —Si(CH₃)₃, and
x and y each represents 0 or a positive integer, and
an infrared absorbing compound which shows a light absorption peak at a wavelength ranging from 700 to 1000 nm.

2. The color imaging toner according to claim 1, wherein the calixarene compound is a compound of the following formula (II):

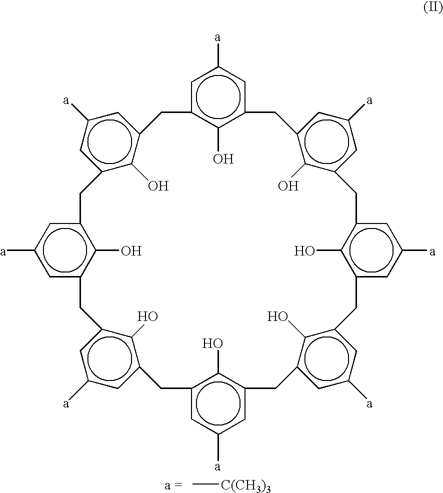

3. The color imaging toner according to claim 1 or 2, wherein the infrared absorbing compound is phthalocyanine, naphthalocyanine or a mixture thereof.

4. The color imaging toner according to claim 1 or 2, wherein 100 parts by weight of a toner is mixed with 0.1 to 10 parts by weight of the calixarene compound and 0.01 to 5 parts by weight of the infrared absorbing compound.

5. The color imaging toner according to claim 1 or 2, wherein the photofixing system is used at a light emission energy density ranging from 1.0 to 6.0 J/cm².

6. The color imaging toner according to claim 1 or 2, wherein the color toner is used in an electrographic imaging process employing a photofixing system.

7. A method of forming a color image on a recording medium by means of an electrophotographic system which comprises the steps of forming an electrostatic latent image by image exposure, visualizing the electrostatic latent image by development, transferring the visualized image onto the recording medium and fixing the transferred image, wherein
a developing agent used in the step of developing the electrostatic latent image contains a color toner comprising at least a binder resin and a colorant and further comprising a combination of:
a calixarene compound represented by the above formula (I) wherein R¹, R², R³, R⁴ and R⁵, R¹¹, R¹², R¹³, R¹⁴ and R¹⁵, and x and y are as defined above, and
an infrared absorbing compound which shows a light absorption peak at a wavelength ranging from 700 to 1000 nm; and
a photofixing system is used at a light emission energy density ranging from 1.0 to 6.0 J/cm² in the step of fixing the transferred image after transferring the image visualized by using the developing agent onto the recording medium.

8. The color image forming method according to claim 7, wherein the calixarene compound is a compound of the above formula (II).

9. The color image forming method according to claim 7 or 8, wherein the infrared absorbing compound is phthalocyanine, naphthalocyanine or a mixture thereof.

10. The color image forming method according to claim 7 or 8, wherein 100 parts by weight of a toner is mixed with 0.1 to 10 parts by weight of the calixarene compound and 0.01 to 5 parts by weight of the infrared absorbing compound.

11. An apparatus for forming a color image on a recording medium by means of an electrophotographic system, comprising an image exposing device for forming an electrostatic latent image, a developing device for visualizing the electrostatic latent image, an image transferring device for transferring the visualized image onto the recording medium, and an image fixing device for fixing the transferred image onto the recording medium, wherein
the developing device is loaded with a developing agent which contains a color toner comprising at least a binder resin and a colorant and further comprising a combination of:
a calixarene compound represented by the above formula (I) wherein R¹, R², R³, R⁴ and R⁵, R¹¹, R¹² R¹³, R¹⁴ and R¹⁵, and x and y are as defined above, and
an infrared absorbing compound which shows a light absorption peak at a wavelength ranging from 700 to 1000 nm; and
the image fixing device is provided with a photofixing device having a light emission energy density ranging from 1.0 to 6.0 J/cm².

12. The color image forming apparatus according to claim 11, wherein the calixarene compound is a compound of the above formula (II).

13. The color image forming apparatus according to claim 11 or 12, wherein the infrared absorbing compound is phthalocyanine, naphthalocyanine or a mixture thereof.

14. The color image forming apparatus according to claim 11 or 12, wherein 100 parts by weight of a toner is mixed with 0.1 to 10 parts by weight of the calixarene compound and 0.01 to 5 parts by weight of the infrared absorbing compound.
